(19) United States
(12) Patent Application Publication
(10) Pub. No.: US 2023/0365020 A1
(43) Pub. Date: Nov. 16, 2023

(54) SMART ROUTING TO EXTEND BATTERY LIFE OF ELECTRIFIED VEHICLES

(71) Applicant: FORD GLOBAL TECHNOLOGIES, LLC, Dearborn, MI (US)

(72) Inventors: Jinwoo SEOK, Ann Arbor, MI (US); Mark John JENNINGS, Saline, MI (US); Ryan O'GORMAN, Beverly Hills, MI (US); Stuart C. SALTER, White Lake, MI (US); Xiaohong Nina DUAN, Canton, MI (US); Gabrielle VUYLSTEKE, Ann Arbor, MI (US); Michael David BEENEY, Canton, MI (US)

(21) Appl. No.: 17/745,227

(22) Filed: May 16, 2022

(51) Int. Cl. B60L 53/66; B60L 53/63; B60L 58/13; B60L 53/64; B60L 58/16

(52) U.S. Cl. CPC B60L 53/66; B60L 53/63; B60L 58/13; B60L 53/64; B60L 58/16

(57) ABSTRACT

Systems and methods are provided for routing one or more electrified vehicles in a manner that improves battery life. The proposed systems and methods may utilize a multi-objective approach to route planning. The multi-objective approach may account for factors such as time, energy consumption, and battery life. Origin-destination matrices may be leveraged for providing the multi-objective route planning approaches.

### TECHNICAL FIELD

This disclosure relates generally to systems and methods for providing a multi-objective route planning strategy for electrified vehicles.

### BACKGROUND

Electrified vehicles differ from conventional motor vehicles because they are selectively driven by one or more traction battery pack powered electric machines. The electric machines can propel the electrified vehicles instead of, or in combination with, an internal combustion engine.

Some electrified vehicles may be operated in the commercial context as part of a vehicle fleet. Replacing the traction battery pack of a fleet vehicle is relatively expensive and thus extending battery life may be desirable for vehicle fleeter managers.

### SUMMARY

A fleet management system according to an exemplary aspect of the present disclosure includes, among other things, an electrified vehicle including a traction battery pack, and a control module programmed to create a smart routing control strategy that includes instructions for routing the electrified vehicle along a drive route in a manner that extends an operable life of the traction battery pack. The instructions are derived based on a weighted sum cost associated with operating the electrified vehicle along a link of an expected operational area of the electrified vehicle.

In a further non-limiting embodiment of the foregoing system, a second electrified vehicle includes a second traction battery pack.

In a further non-limiting embodiment of either of the foregoing systems, the smart routing control strategy includes additional instructions for routing the second electrified vehicle in a manner that extends an operable life of the second traction battery pack.

In a further non-limiting embodiment of any of the foregoing systems, the additional instructions are derived based on a second total weighed sum cost associated with operating the second electrified vehicle along a link of a second expected operational area of the second electrified vehicle.

In a further non-limiting embodiment of any of the foregoing systems, the control module is a component of a cloud-based server system.

In a further non-limiting embodiment of any of the foregoing systems, the cloud-based server system is operably connected to a map data server, a traffic data server, a weather data server, and a charging station server. The weighted sum cost is derived using information from each of the map data server, the traffic data server, the weather data server, and the charging station server.

In a further non-limiting embodiment of any of the foregoing systems, the instructions include a charging/parking strategy for resting after the electrified vehicle completes the drive route.

In a further non-limiting embodiment of any of the foregoing systems, the weighted sum cost is a weighted sum of an energy consumption cost, a travel time cost, and a battery life degradation cost associated with operating the electrified vehicle over the link.

In a further non-limiting embodiment of any of the foregoing systems, the control module is further programmed to generate an origin-destination matrix for deriving the weighted sum cost.

In a further non-limiting embodiment of any of the foregoing systems, the control module is configured to execute a shortest path algorithm and an optimization algorithm for preparing the smart routing control strategy.

An electrified vehicle according to another exemplary aspect of the present disclosure includes, among other things, a traction battery pack and a control module programmed to receive a smart routing control strategy that includes instructions for routing the electrified vehicle along a drive route in a manner that extends an operable life of the traction battery pack. The smart routing control strategy is derived based on a weighted sum cost associated with operating the electrified vehicle along a link of an expected operational area of the electrified vehicle.

In a further non-limiting embodiment of the foregoing electrified vehicle, the instructions include a charging/parking strategy for resting after the electrified vehicle completes the drive route.

In a further non-limiting embodiment of either of the foregoing electrified vehicles, the weighted sum cost is a weighted sum of an energy consumption cost, a travel time cost, and a battery life degradation cost associated with operating the electrified vehicle over the link.

In a further non-limiting embodiment of any of the foregoing electrified vehicles, the smart routing control strategy is further derived based on an origin-destination matrix.

In a further non-limiting embodiment of any of the foregoing electrified vehicles, the smart routing control strategy is further derived via a shortest path algorithm and an optimization algorithm.

In a further non-limiting embodiment of any of the foregoing electrified vehicles, the smart routing control strategy is received from a cloud-based server system.

In a further non-limiting embodiment of any of the foregoing electrified vehicles, the electrified vehicle is part of a vehicle fleet.

In a further non-limiting embodiment of any of the foregoing electrified vehicles, the electrified vehicle is a plug-in type electrified vehicle.

In a further non-limiting embodiment of any of the foregoing electrified vehicles, the weighted sum cost is generated based on information from each of a map data server, a traffic data server, a weather data server, and a charging station server.

A route planning method according to another exemplary aspect of the present disclosure includes, among other things, generating a road network that defines an expected operational area an electrified vehicle will travel within during an upcoming trip, and performing an objective based total cost analysis for determining a lowest cost travel path for completing the upcoming trip. The objective based total cost analysis includes analyzing an energy consumption cost, a travel time cost, and a battery life degradation cost associated with operating the electrified vehicle, and generating a smart routing control strategy for routing the electrified vehicle along the lowest cost travel path during the upcoming trip.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a fleet management system for coordinating vehicle routing functions in a manner that extends battery life.

FIG. 2 schematically illustrates an exemplary road network that can be generated by the fleet management system of FIG. 1 when performing vehicle routing functions.

FIG. 3 illustrates an origin-destination matrix that can be generated by the fleet management system of FIG. 1 when performing vehicle routing functions.

FIG. 4 schematically illustrates a control system of an exemplary fleet management system.

FIG. 5 is a flow chart of an exemplary method for coordinating and providing a smart routing control strategy for routing electrified vehicles in a manner that influences battery life.

### DETAILED DESCRIPTION

This disclosure relates to systems and methods for routing one or more electrified vehicles in a manner that improves battery life. The proposed systems and methods may utilize a multi-objective approach to route planning. The multi-objective approach may account for factors such as time, energy consumption, and battery life. Origin-destination matrices may be leveraged for providing the multi-objective route planning approaches. These and other features of this disclosure are discussed in greater detail in the following paragraphs of this detailed description.

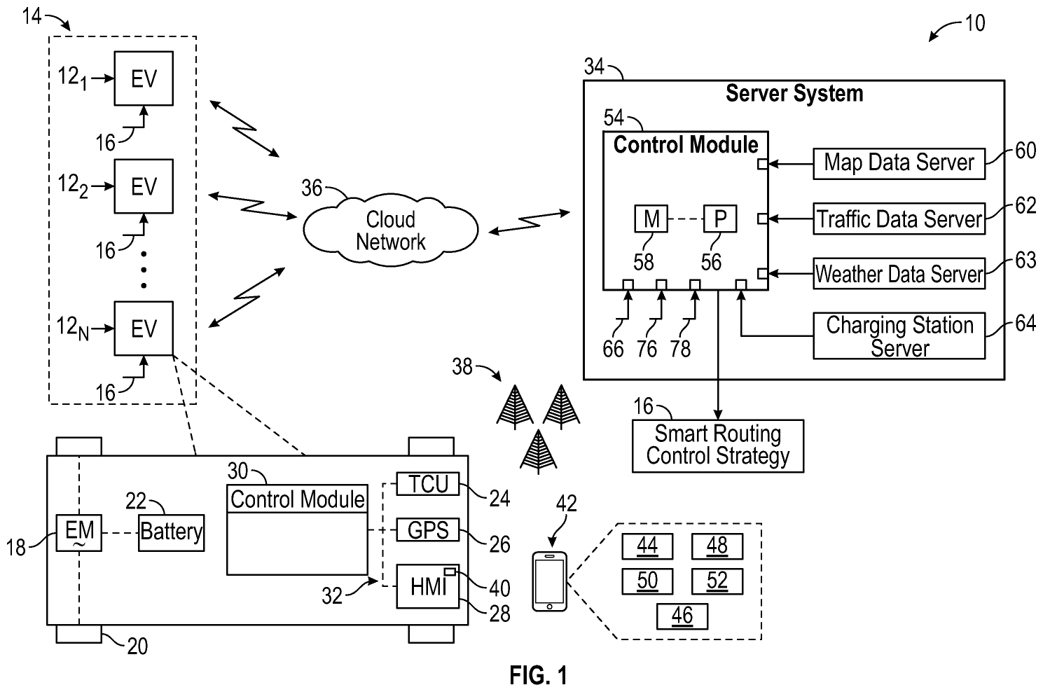

FIG. 1 schematically illustrates a fleet management system 10 (hereinafter “the system 10”) for performing route planning tasks associated with a vehicle fleet 14. Among other functions, the system 10 may be configured for generating a smart routing control strategy 16 for routing each electrified vehicle 12 of the vehicle fleet 14 in a manner that extends battery life.

The vehicle fleet 14 may include a plurality of electrified vehicles 12₁-12_{N}, where “N” represents any number. The total number of electrified vehicles 12 associated with the vehicle fleet 14 is not intended to limit this disclosure. Unless stated otherwise herein, reference numeral “12” refers to any of the electrified vehicles when used without any alphabetic identifier immediately following the reference numeral.

The electrified vehicles 12 are schematically illustrated in FIG. 1, and each such vehicle could embody any type of vehicle configuration, such as car, a truck, a van, a sport utility vehicle (SUV), etc. In an embodiment, each electrified vehicle 12 is a plug-in type electrified vehicle (e.g., a plug-in hybrid electric vehicle (PHEV) or a battery electric vehicle (BEV)) or a fuel cell vehicle. In some implementations, one or more of the electrified vehicles 12 of the vehicle fleet 14 could be configured as an autonomous vehicle (i.e., a driverless vehicle).

Although a specific component relationship is illustrated in the figures of this disclosure, the illustrations are not intended to limit this disclosure. The placement and orientation of the various components of the depicted electrified vehicles are shown schematically and could vary within the scope of this disclosure. In addition, the various figures accompanying this disclosure are not necessarily drawn to scale, and some features may be exaggerated or minimized to emphasize certain details of a particular component.

Each electrified vehicle 12 may include an electrified powertrain capable of applying a torque from one or more electric machines 18 (e.g., electric motors) for driving one or more drive wheels 20. Each electrified vehicle 12 may further include a traction battery pack 22 for powering the electric machine 18 and other electrical loads of the electrified vehicle 12. The powertrain of each electrified vehicle 12 may electrically propel the drive wheels 20 either with or without assistance from an internal combustion engine.

Although shown schematically, the traction battery pack 22 of each electrified vehicle 12 may be configured as a high voltage traction battery pack that includes a plurality of battery arrays (i.e., battery assemblies or groupings of battery cells) capable of outputting electrical power to the electric machine 18. Other types of energy storage devices and/or output devices may also be used to electrically power the electrified vehicle 12.

Each electrified vehicle 12 may further include a telecommunications module 24, a global positioning system (GPS) 26, a human machine interface (HMI) 28, and a control module 30. These and other components may be interconnected and in electronic communication with one another over a communication bus 32. The communication bus 32 may be a wired communication bus such as a controller area network (CAN) bus, or a wireless communication bus such as Wi-Fi, Bluetooth®, Ultra-Wide Band (UWB), etc.

Each telecommunications module 24 may be configured for achieving bidirectional communications with a cloud-based server system 34, for example. The telecommunications modules 24 may communicate over a cloud network 36 (e.g., the internet) to obtain various information stored on the server system 34 or to provide information to the server system 34. The server system 34 can identify, collect, and store user data associated with each electrified vehicle 12 for validation purposes. Upon an authorized request, data may be subsequently transmitted to each telecommunications module 24 via one or more cellular towers 38 or some other known communication technique (e.g., Wi-Fi, Bluetooth®, data connectivity, etc.). The telecommunications modules 24 can receive data from the server system 34 or can communicate data back to the server system 34 via the cellular tower(s) 38. Although not necessarily shown or described in this highly schematic embodiment, numerous other components may enable bidirectional communications between each electrified vehicle 12 and the server system 34.

In a first embodiment, an operator of each electrified vehicle 12 may interface with the server system 34 using the HMI 28. For example, the HMI 28 may be equipped with an application 40 (e.g., FordPass™ or another similar web-based application) for allowing users to interface with the server system 34. The HMI 28 may be located within a passenger cabin of the electrified vehicle 12 and may include various user interfaces for displaying information to the vehicle occupants and for allowing the vehicle occupants to enter information into the HMI 28. The vehicle occupants may interact with the user interfaces presentable on the HMI 28 via touch screens, tactile buttons, audible speech, speech synthesis, etc.

In another embodiment, the operator of each electrified vehicle 12 may alternatively or additionally interface with the server system 34 using a personal electronic device 42 (e.g., a smart phone, tablet, computer, wearable smart device, etc.). The personal electronic device 42 may include an application 44 (e.g., FordPass™ or another similar application) that includes programming to allow the user to employ one or more user interfaces 46 for interfacing with the server system 34, setting or controlling certain aspects of the system 10, etc. The application 44 may be stored in a memory 48 of the personal electronic device 42 and may be executed by a processor 50 of the personal electronic device 42. The personal electronic device 42 may additionally include a transceiver 52 that is configured to communicate with the server system 34 over the cellular tower(s) 38 or some other wireless link.

Each GPS 26 may be configured to pinpoint locational coordinates of its respective electrified vehicle 12. The GPS 26 may utilize geopositioning techniques or any other satellite navigation techniques for estimating the geographic position of the electrified vehicle 12 at any point in time. In an embodiment, GPS data from the GPS 26 may be used to determine the weather and traffic data that is most relevant to the electrified vehicle 12 at any point in time.

Each control module 30 may include both hardware and software and could be part of an overall vehicle control system, such as a vehicle system controller (VSC), or could alternatively be a stand-alone controller separate from the VSC. In an embodiment, the control module 30 is programmed with executable instructions for interfacing with various components of the system 10. Although shown as separate modules within the highly schematic depiction of FIG. 1, the telecommunications module 24, the GPS 26, the HMI 28, and the control module 30 could be integrated together as part of common module within each of the electrified vehicles 12.

The server system 34 may include a control module 54 that is configured for coordinating and executing various control strategies and modes associated with the system 10. For example, the control module 54 may be programmed for performing various route planning functions of the system 10. The control module 54 may include both a processor 56 and non-transitory memory 58. The processor 56 may be a custom made or commercially available processor, a central processing unit (CPU), a high performance computing (HPC) device, a clustering device, a quantum computing (QC) device, a quantum inspired optimization (QIO) device, or generally any device for executing software instructions. The memory 58 may include any one or combination of volatile memory elements and/or nonvolatile memory elements.

The processor 56 may be operably coupled to the memory 58 and may be configured to execute one or more programs (e.g., algorithms) stored in the memory 58 of the control module 54 based on various inputs, such as inputs received from each of the electrified vehicles 12 and inputs received from one or more servers associated with the server system 34. Information may be exchanged between the control module 54, the electrified vehicles 12, and the servers via one or more application programming interfaces, for example.

The control module 54 may receive inputs from each of a map data server 60, a traffic data server 62, a weather data server 63, and a charging station server 64. Although shown schematically as establishing separate servers, one or more of the map data server 60, the traffic data server 62, the weather data server 63, and the charging station server 64 could be combined together as part of a single server.

The map data server 60 may store data related to a road network for a geographical area. The data may include geospatial information (e.g., objects, elevations/grades, events, phenomena, etc.) related to or containing information specific to each roadway node and link of the road network.

The traffic data server 62 may store data related to up-to-date and predicted traffic conditions associated with the roadways of a road network for any given location. The traffic related data may include, but is not limited to, traffic congestion information, emergency service dispatch information, etc. The traffic related data stored on the traffic data server 62 could be derived based on news feed information or crowd sourced information.

The weather data server 63 may store weather related data. The weather related data may include, but is not limited to, region specific weather history for a given locational area, storm metrics including current and forecasted windspeeds, current and forecasted rain fall or snowfall, current and forecasted temperatures, current and forecasted barometric pressures, presence and/or likelihood of extreme weather (e.g., heat waves, tornados, hurricanes, heavy snow fall/blizzards, wild fires, torrential rain falls, etc.), and current and forecasted trajectory of storms for any given location. The weather data server 63 may be operated or managed, for example, by an organization such as the national weather service. Alternatively, the weather data server 63 may collect weather/climate related data from weather stations, news stations, remote connected temperature sensors, connected mobile device database tables, etc. The weather related data stored on the weather data server 63 could also be derived from crowd sourced weather information.

The charging station server 64 may store data pertaining to charging stations that are located within a relevant road network. The charging station related data may include the location of each charging station, the type of charging station offered at each charging station, the charging fee associated with each charging station, etc.

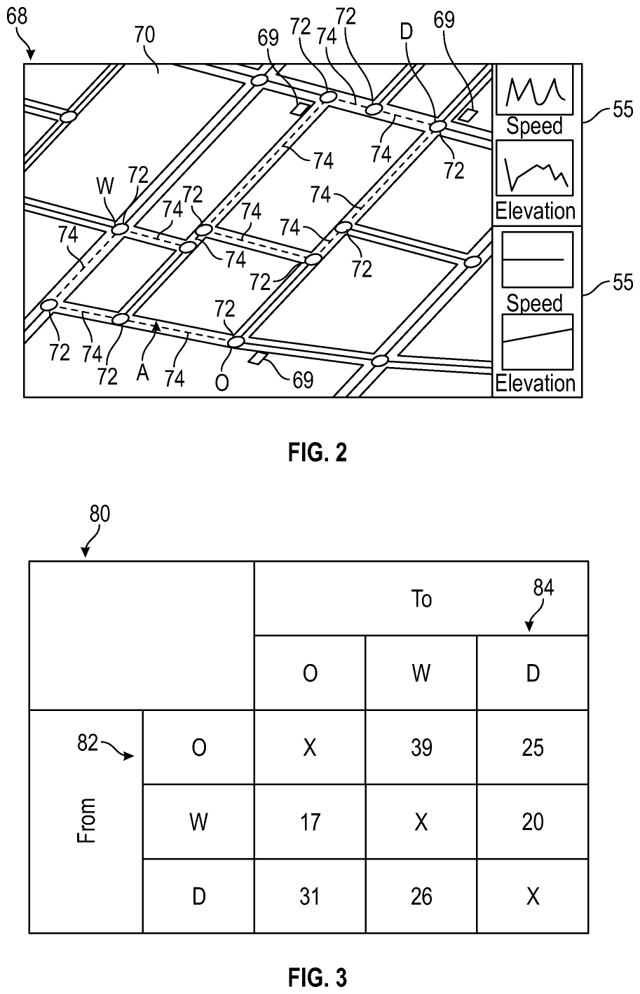

The control module 54 may be programmed to leverage trip planner information 66 received from each electrified vehicle 12 and map data received from the map data server 60 for generating a road network 68 (see FIG. 2). The road network 68 may define the relevant operational area for each electrified vehicle 12 of the vehicle fleet 14. The trip planner information 66 may include various information, including but not limited to identifying an origin, one or more destinations, and one or more waypoints that the electrified vehicle 12 will travel to during an upcoming trip.

An exemplary road network 68 that may be generated by the control module 54 is illustrated in FIG. 2. The road network 68 may include a street map 70 made up of a plurality of nodes 72 and links 74 that delineate a relevant operational area A for a given electrified vehicle 12. Each link 74 may extend between two of the nodes 72. An origin point O, each destination point D, and each waypoint W may be derived from the trip planner information 66 and may be identified within the road network 68. Further, a location of one or more charging stations 69 located within the operational area A may be identified within the road network 68.

Referring now to FIGS. 1 and 2, the control module 54 of the server system 34 may leverage inputs from the map data server 60, the traffic data server 62, and the weather data server 63 to assign geospatial, traffic, and weather related information to each link 74 of the road network 68. This type of information is schematically depicted at reference numerals 55 in FIG. 2. The control module 54 may further leverage inputs from the charging station server 64 to assign charging station information to one or more of the links 74 of the road network 68. The geospatial, traffic, weather, and charging station related information can influence various factors specific to each electrified vehicle 12, such as the amount of time it will take to travel over each link 74, the amount of energy that will be consumed in order to travel over each link 74, battery degradation that will be incurred to travel each link 74, battery degradation that will occur when charging at each charging station 69 along the route, etc. The geospatial, traffic, weather, and charging station related information may therefore be considered by the control module 54 when performing route planning functions for the vehicle fleet 14.

The control module 54 may be further programmed to leverage vehicle information 76 and battery information 78 received from each electrified vehicle 12 for estimating a total cost associated with traveling along each link 74 during a planned trip. The vehicle information 76 may include but is not limited to vehicle locations, cabin temperature, ambient temperature, etc. The battery information 78 may include but is not limited to current state of charge, battery health information, battery temperature, etc. The control module 54 may consider factors such as the amount of time it will take to travel the link 74, the amount of energy from the traction battery pack 22 that will be consumed in order to travel the link 74, and the impact on the battery life of the traction battery pack 22 that will be incurred by traveling the link 74 (e.g., by referencing battery degradation models) for estimating the total cost associated with each link 74.

The control module 54 may be further programmed to leverage information received from the charging station server 64 for estimating a total cost associated with charging at each relevant charging station 69 of the road network 68. The control module 54 may consider factors such as the amount of time it will take to charge at each charging station 69 and the impact on the battery life of the traction battery pack 22 that will be incurred by charging at each charging station 69 (e.g., by referencing charging degradation maps) for estimating the total cost associated with each charging station 69.

In an embodiment, the total cost of each link 74 may be equal to the weighted sum of the energy consumption cost, the travel time cost, and battery life degradation cost. The total cost associated with each link 74 may therefore be calculated using the following equation (1):

Cᵢ=wₑᵢCₑᵢ+wₜᵢcₜᵢ+w_{bi}c_{bi} (1)
Where:
Cᵢ is the weighted sum cost of the link;
wₑᵢ is the weight of the energy consumption cost;
cₑᵢ is the energy consumption cost of the link;
wₜᵢ is the weight of the travel time cost;
cₜᵢ is the travel time cost of the link;
w_{bi} is the weight of the battery life degradation cost; and
c_{bi} is the battery life degradation cost of the link.

Other approaches and equations could alternatively be used to determine the weighted sum cost. The weighted sum cost may be expressed as an actual time (second, hour, etc.) energy (J), and/or capacity degradation (wh), or alternatively could be a unitless value that represents time, energy, and/or battery life.

The control module 54 may be further programmed to create an origin-destination matrix 80 (see FIG. 3) that can be derived based on the calculated weighted sum cost Cᵢ for each link 74. In an embodiment, each weighted sum cost Cᵢ may be input into a shortest path algorithm for generating the origin-destination matrix 80. The shortest path algorithm may be represented by the following equation (2), subject to any state of charge constraints:

c*(N)=minΣₙ_{ₚ}_{∈N}C(nₚnₚ₊₁) (2)
Where:
C* is the optimal (minimum) cost to go from a given origin to a given destination;
nₚ is the node ‘p’ in node set ‘N’; and
(nₚ, nₚ₊₁) is the cost of the link that is from node ‘nₚ’ to next node ‘nₚ₊₁’.

An exemplary origin-destination matrix 80 is illustrated in FIG. 3. The origin-destination matrix 80 may list the origin point O, the one or more destination points D, and the one or more waypoints W along both a row portion 82 and a column portion 84 of the origin destination matrix 80. In the illustrated embodiment, the “from” locations O, D, and W are listed in the row portion 82, and the “to” locations O, D, W are listed in the column portion 84.

The origin-destination matrix 80 may further list the weighted sum costs Cᵢ associated with traveling from each of the “from” locations to each of the “to” locations indicated by the row portion 82 and the column portion 84. In this disclosure, higher number indicate higher weighted sum costs and lower numbers indicate lower weighted sum costs.

Referring now to FIGS. 1-3, the control module 54 may utilize the information contained within the origin-destination matrix 80 to determine the most efficient travel path, including for traveling to any waypoints, in terms of weighted sum costs, for each electrified vehicle 12. In an embodiment, the control module 54 may be programmed to utilize a modified simulated annealing algorithm for determining the most efficient path for each electrified vehicle 12 for traveling between the origin point O, the destination point D, and the waypoint W. The modified simulated annealing algorithm may be used to solve the following optimization problem represented in equation (3), subject to constraints such as vehicle capacity, travel time, etc.:

J*(k,t,S)=minΣ_{S,k}OD(k)(t,wₚ,wₚ₊₁)+c_{c}(t)+c_{bp}(t_{end}) (3)
Where:
J* is the optimal (minimum) cost to visit all waypoints;
s is the set of all waypoints that want to be visited;
w_{D} is the waypoint ‘p’ in waypoint set ‘S’;
OD(k) (t,wₚ,wₚ₊₁) is the cost to travel from waypoint ‘wₚ’ to the waypoint
‘wₚ₊₁’ at time ‘t’ in OD matrix, for OD matrix type ‘k’;
c_{c} is the cost of charging station (charging time cost & battery degradation cost); and
c_{bp} is the cost of parking (battery degradation cost).

In the example illustrated by the origin-destination matrix 80 of FIG. 3, the control module 54 can determine that the optimal minimum cost travel path for the given electrified vehicle 12 is to first travel from the origin point O to the one or more waypoints W, and then from the last waypoint W to the destination D. Notably, the destination D could be the same as the origin point O. This travel path would result in a weighted sum cost of 68, which is lower than the weighted sum costs associated with the other travel path combinations indicated by the origin-destination matrix 80.

Based on the outputs of equation (3), the control module 54 may generate the smart routing control strategy 16. The smart routing control strategy 16 may include routing instructions for routing each electrified vehicle 12 of the vehicle fleet 14. The routing instructions may include, among other things, the travel path each electrified vehicle 12 should take, when each vehicle travel along the desired path, when and where to charge along the path if current energy levels are insufficient to complete the planned trip, etc. The routing instructions may be presented on the HMI 28 and/or the personal electronic device 42 associated with each electrified vehicle 12, for example.

As alluded to in equation (3), the control module 54 may consider charging/parking strategies for resting after each electrified vehicle 12 completes its trip as part of the route planning functionality of the system 10. For example, the smart routing control strategy 16 may allot for stops at charging stations 69 along the drive route that offer charging levels that provide an optimal state of charge of the traction battery pack 22 during parking/resting for achieving better battery life. Charging and parking degradation maps may be leveraged for providing the best charging/parking strategy for a given situation, including for suggesting the best charging time for the next upcoming trip. Moreover, temperatures at various parking locations may be considered in relationship to the ability to discharge the energy stored in the traction battery pack 22 during resting.

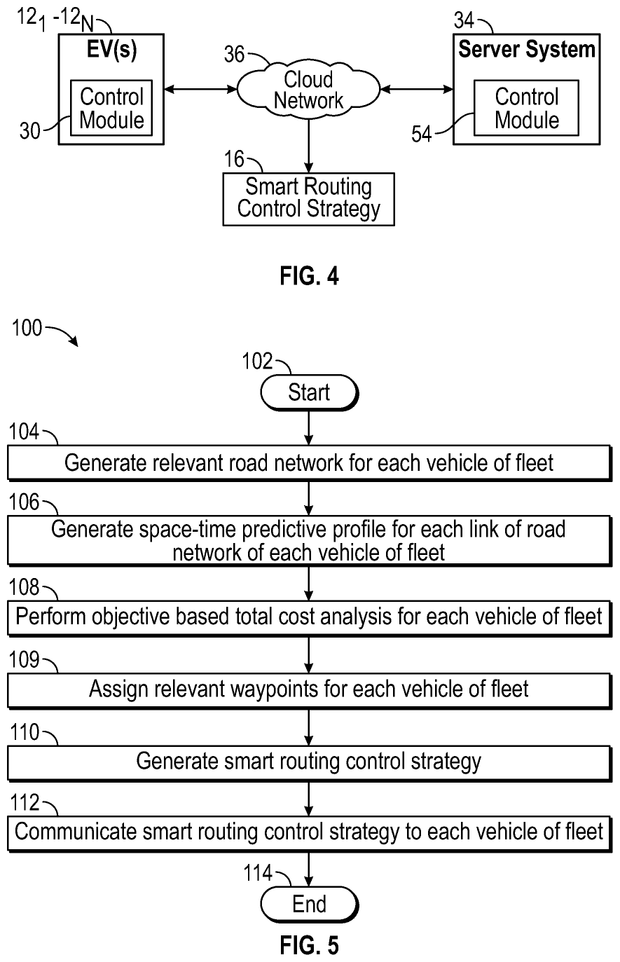

In the embodiments described above, the control module 54 of the server system 34 is configured to function as the communications hub of the system 10. However, other embodiments are also contemplated within the scope of this disclosure. For example, as schematically shown in FIG. 4, the control modules 30 of each electrified vehicle 12 of the vehicle fleet 14 and the control module 54 of the server system 34 may operate together over the cloud network 36 to establish a smart routing control system for preparing the smart routing control strategy 16. In still other embodiments, the smart routing control strategy 16 could implemented on an individual vehicle basis (e.g., within the control module 30 of an electrified vehicle 12) to provide smart routing solutions to individual, non-fleet customers.

FIG. 5, with continued reference to FIGS. 1-4, schematically illustrates in flow chart form an exemplary method 100 for coordinating and executing the smart routing control strategy 16 of the system 10. Per the method 100, the smart routing control strategy 16 may be created to provide routing instructions for routing each electrified vehicle 12 of the vehicle fleet 14 in a manner that improves battery life, for example.

The system 10 may be configured to employ one or more algorithms adapted to execute at least a portion of the steps of the exemplary method 100. For example, the method 100 may be stored as executable instructions in the memory 58 of the control module 54, and the executable instructions may be embodied within any computer readable medium that can be executed by the processor 56 of the control module 54. The method 100 could alternatively or additionally be stored as executable instructions in the memories of the control modules 30 of one or more of the electrified vehicles 12.

The exemplary method 100 may begin at block 102. At block 104, the method 100 may generate a relevant road network 68 for each electrified vehicle 12 of the vehicle fleet 14. This step may include identifying all relevant nodes 72 and links 74 associated with the operational area A for each road network 68.

Next, at block 106, the method 100 may generate a space-time predictive profile that accounts for factors such as speed, weather, grade, and other road characteristics for each link 74 of each road network 68. This may include considering inputs such as information from each of the map data server 60, the traffic data server 62, the weather data server 63, and the charging station server 64.

The method 100 may then perform an objective based total cost analysis at block 108. This step may include utilizing each of equations (1) and (2) and preparing multiple origin-destination matrices 80 for determining the most efficient (e.g., low cost) travel path for each electrified vehicle 12. Relevant waypoints may be assigned to each vehicle of the fleet using equation (3) at block 109.

The smart routing control strategy 16 may be generated at block 110. The method 100 may then communicate the smart routing control strategy 16 to each electrified vehicle 12 of the vehicle fleet 14 at block 112. The method 100 may then end at block 114.

The electrified vehicle fleet management systems of this disclosure are designed to provide smart routing functionality for guiding each vehicle of the fleet during planned trips. The proposed systems and methods provide for a multi-objective (e.g., time, energy, and battery life) optimization of vehicle routing.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A fleet management system, comprising:
an electrified vehicle including a traction battery pack; and
a control module programmed to create a smart routing control strategy that includes instructions for routing the electrified vehicle along a drive route in a manner that extends an operable life of the traction battery pack,
wherein the instructions are derived based on a weighted sum cost associated with operating the electrified vehicle along a link of an expected operational area of the electrified vehicle.

2. The system as recited in claim 1, comprising a second electrified vehicle including a second traction battery pack.

3. The system as recited in claim 2, wherein the smart routing control strategy includes additional instructions for routing the second electrified vehicle in a manner that extends an operable life of the second traction battery pack.

4. The system as recited in claim 3, wherein the additional instructions are derived based on a second total weighed sum cost associated with operating the second electrified vehicle along a link of a second expected operational area of the second electrified vehicle.

5. The system as recited in claim 1, wherein the control module is a component of a cloud-based server system.

6. The system as recited in claim 5, wherein the cloud-based server system is operably connected to a map data server, a traffic data server, a weather data server, and a charging station server, and further wherein the weighted sum cost is derived using information from each of the map data server, the traffic data server, the weather data server, and the charging station server.

7. The system as recited in claim 1, wherein the instructions include a charging/parking strategy for resting after the electrified vehicle completes the drive route.

8. The system as recited in claim 1, wherein the weighted sum cost is a weighted sum of an energy consumption cost, a travel time cost, and a battery life degradation cost associated with operating the electrified vehicle over the link.

9. The system as recited in claim 1, wherein the control module is further programmed to generate an origin-destination matrix for deriving the weighted sum cost.

10. The system as recited in claim 1, wherein the control module is configured to execute a shortest path algorithm and a modified simulated annealing algorithm for preparing the smart routing control strategy.

11. An electrified vehicle, comprising:
a traction battery pack; and
a control module programmed to receive a smart routing control strategy that includes instructions for routing the electrified vehicle along a drive route in a manner that extends an operable life of the traction battery pack,
wherein the smart routing control strategy is derived based on a weighted sum cost associated with operating the electrified vehicle along a link of an expected operational area of the electrified vehicle.

12. The electrified vehicle as recited in claim 11, wherein the instructions include a charging/parking strategy for resting after the electrified vehicle completes the drive route.

13. The electrified vehicle as recited in claim 11, wherein the weighted sum cost is a weighted sum of an energy consumption cost, a travel time cost, and a battery life degradation cost associated with operating the electrified vehicle over the link.

14. The electrified vehicle as recited in claim 11, wherein smart routing control strategy is further derived based on an origin-destination matrix.

15. The electrified vehicle as recited in claim 11, wherein the smart routing control strategy is further derived via a shortest path algorithm and a modified simulated annealing algorithm.

16. The electrified vehicle as recited in claim 11, wherein the smart routing control strategy is received from a cloud-based server system.

17. The electrified vehicle as recited in claim 11, wherein the electrified vehicle is part of a vehicle fleet.

18. The electrified vehicle as recited in claim 11, wherein the electrified vehicle is a plug-in type electrified vehicle.

19. The electrified vehicle as recited in claim 11, wherein the weighted sum cost is generated based on information from each of a map data server, a traffic data server, a weather data server, and a charging station server.

20. A route planning method, comprising:
generating a road network that defines an expected operational area an electrified vehicle will travel within during an upcoming trip;
performing an objective based total cost analysis for determining a lowest cost travel path for completing the upcoming trip,
wherein the objective based total cost analysis includes analyzing an energy consumption cost, a travel time cost, and a battery life degradation cost associated with operating the electrified vehicle, and
generating a smart routing control strategy for routing the electrified vehicle along the lowest cost travel path during the upcoming trip.
